(19) United States
(12) Patent Application Publication
(10) Pub. No.: US 2004/0102965 A1
(43) Pub. Date: May 27, 2004

(54) Determining a pitch period

(76) Inventor: Ezra J. Rapoport, (US)

Correspondence Address: FISH & RICHARDSON PC, 225 FRANKLIN ST, BOSTON, MA, 02110, US

(21) Appl. No.: 10/624,139

(22) Filed: Jul. 21, 2003

Related U.S. Application Data
(60) Provisional application No. 60/428,551, filed on Nov. 21, 2002.

(51) Int. Cl. G10L 11/04

(52) U.S. Cl. 704/207

(57) ABSTRACT

A method of determining a pitch period includes determining a first primary peak of an input signal. The method also includes determining a second primary peak of the input signal by locating a maximum peak from a series of peaks centered a period of time, equal to a prior pitch period, from the first primary peak.

### PRIORITY TO OTHER APPLICATIONS

This application claims priority from and incorporates herein U.S. Provisional Application No. 60/428,551, filed Nov. 21, 2002, and titled “Speech Compression Using Principal Component Analysis.”

### BACKGROUND

This invention relates to pitch periods.

In a typical communications system, a message is sent from a transmitter to a receiver over a channel. The rate at which the information is received by the receiver is limited by the bandwidth of the channel and the amount of information sent. One way to improve communications is to widen the bandwidth. However, in most situations, the bandwidth is fixed due to the infrastructure of wires, fiber optics, etc.

Another way to improve the rate of information received is to compress the information. The ultimate goal of compression is to store data more efficiently by reducing the bandwidth required to transmit a given amount of information. Compression is also highly valuable for practical reasons, such as reducing costs associated with computer memory and other storage methods.

SUMMARY

Quasi-periodic waveforms can be found in many areas of the natural sciences. Quasi-periodic waveforms are observed in data ranging from heartbeats to population statistics, and from nerve impulses to weather patterns. The “patterns” in the data are relatively easy to recognize. For example, nearly everyone recognizes the signature waveform of a series of heartbeats. However, programming computers to recognize these quasi-periodic patterns is difficult because the data are not patterns in the strictest sense because each quasi-periodic data pattern recurs in a slightly different form with each iteration. The slight pattern variation from one period to the next is characteristic of “imperfect” natural systems. It is, for example, what makes human speech sound distinctly human. The inability of computers to efficiently recognize quasi-periodicity is a significant impediment to the analysis and storage of data from natural systems. Many standard methods require such data to be stored verbatim, which requires large amounts of storage space. Consequently, compression of quasi-periodic data has long been an evasive goal of scientists from diverse fields.

In one aspect the invention is a method of determining a pitch period. The method includes determining a first primary peak of an input signal. The method also includes determining a second primary peak of the input signal by locating a maximum peak from a series of peaks centered a period of time, equal to a prior pitch period, from the first primary peak.

In an another aspect, the invention is an article that includes a machine-readable medium that stores executable instructions for determining a pitch period. The instructions cause a machine to determine a first primary peak of an input signal. The instructions also cause a machine to determine a second primary peak of the input signal by locating a maximum peak from a series of peaks centered a period of timer equal to a prior pitch period, after the first primary peak.

In a further aspect, the invention is an apparatus that includes a memory that stores executable instructions for determining a pitch period. The apparatus also includes a processor that executes the instructions to determine a first primary peak of an input signal. The processor also executes instructions to determine a second primary peak of the input signal by locating a maximum peak from a series of peaks centered a period of time equal to a prior pitch period after the first primary peak.

One or more of the aspects may have one or more of the following features. One feature includes setting a buffer length. Another feature includes setting a vector length. A still other feature includes designating the second primary peak as a first primary peak of a second pitch period subsequent to the pitch period. The feature may also include generating a vector of each pitch period.

The input signal may be a quasi-periodic waveform. The quasi-periodic signal may be a speech waveform. The series of peaks may include six peaks. The buffer length may include 20 sample points at 8 kHz in a speech signal. The vector length may include 120 sample points at 8 kHz in a speech signal. The prior pitch period length may be determined from taking a cepstrum of waveforms prior to the pitch period.

One or more of the aspects above may have one or more of the following advantages. The invention achieves compression rates that surpass the highest standards currently available. These increases in compression translate into savings of processing time and data storage. The method is also suitable for real-time applications such as telecommunications. For example, using only 3 kbps, the method allows for twenty conversations over a single phone line.

### DESCRIPTION OF THE DRAWINGS

FIG. 1 is a block diagram of a telecommunications system.

FIG. 2 is a flowchart of a process to compress speech.

FIG. 3 is a flowchart of a process to determine a pitch period.

FIG. 4 is an input waveform showing the relationship between vector length, buffer length and pitch periods.

FIG. 5 is an amplitude versus time plot of a sampled waveform of a pitch period.

FIGS. 6A-6C are plots representing a relationship between data and principal components.

FIG. 7 is a flowchart of a process to determine principal components and coefficients.

FIG. 8 is a plot of an eigenspectrum for a phoneme.

FIG. 9 is a flowchart of a process to reconstruct waveforms.

FIGS. 10A-10C are plots of principal components.

FIGS. 11A-11F are plots of reconstructed waveforms versus actual waveforms.

FIG. 12 is a plot of distances of pitch periods from their centroid.

FIGS. 13A-13D are graphs of the coefficients for the first four principal components of a waveform.

FIGS. 14A-14B are plots of the same phoneme spoken in different surrounding environments.

FIG. 15 is a flowchart of a process using principal component analysis (PCA) in speech recognition.

FIG. 16 is a flowchart of a process using PCA in speech synthesis.

FIG. 17 is a block diagram of a computer system on which the process of FIG. 2 may be implemented.

### DESCRIPTION

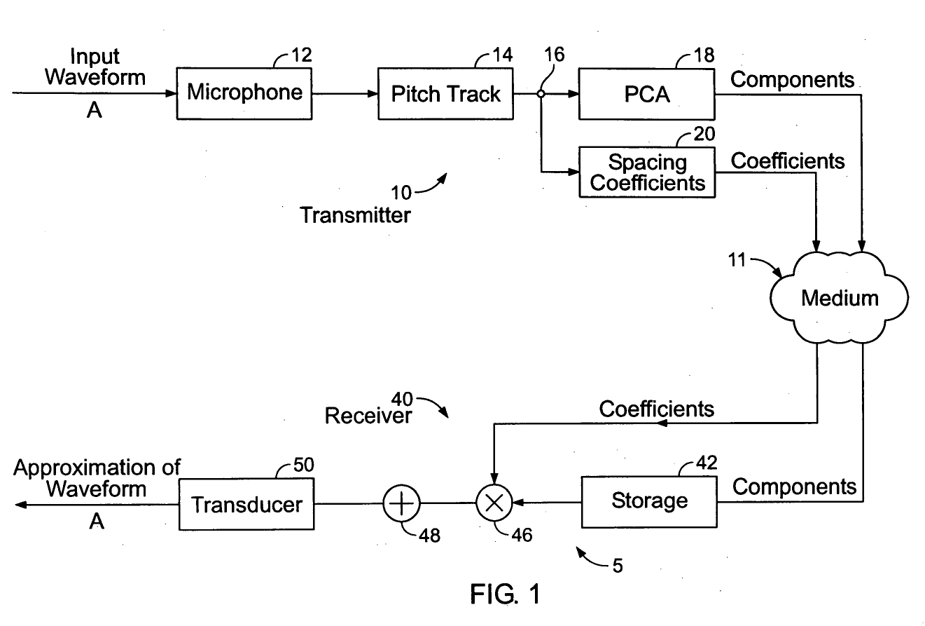

Referring to FIG. 1, a telecommunications system 5 includes a transmitter 10 that sends signals over a medium 11 (e.g., network, atmosphere) to a receiver 40. Transmitter 10 includes a microphone 12 for receiving an input signal, e.g., waveform A, a pitch track analyzer 14, a switch 16, a principal component analysis (PCA) generator 18 and a spacing coefficient generator 20. Principal component analysis (PCA) is a linear algebraic transform. PCA is used to determine the most efficient orthogonal basis for a given set of data. When determining the most efficient axes, or principal components of a set of data using PCA, a strength (i.e., an importance value called herein as a coefficient) is assigned to each principal component of the data set.

The pitch track analyzer 12 determines the pitch periods of the input waveform. A signal switch 16 routes the signal to the PCA generator 18 during an initial calibration period. PCA generator 18 calculates the principal components for the initial pitch period received. PCA Generator 18 sends the first 6 principal components for transmission. After the initial transmission period, switch 16 routes the input signal to coefficient generator 18, which generates coefficients for each subsequent pitch period. Instead of sending the principal components, only the coefficients are sent, thus reducing the number of bits being transmitted. Switch 16 includes a mechanism that determines if the coefficients being used are valid. Coefficients deviating from the original coefficients by more than a predetermined value are rejected and new principal components are determined and hence new coefficients.

Receiver 40 includes a storage device 42 for storing the principal components received from transmitter 10, a multiplier 46, an adder 48 and a transducer 50. Each set of principal components stored in storage 42 is coupled to a corresponding set of coefficients received from transmitter 10. Each coupled product is summed by pitch period to generate an approximation of the waveform A. The result is sent to transducer 50.

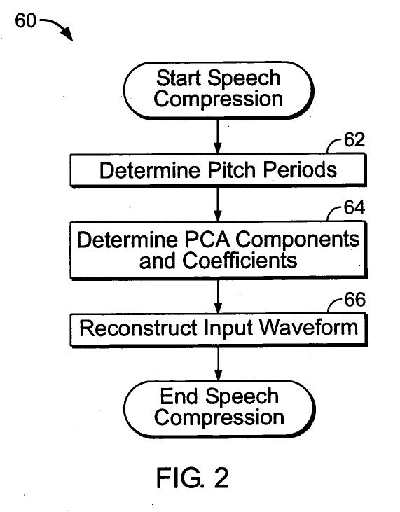

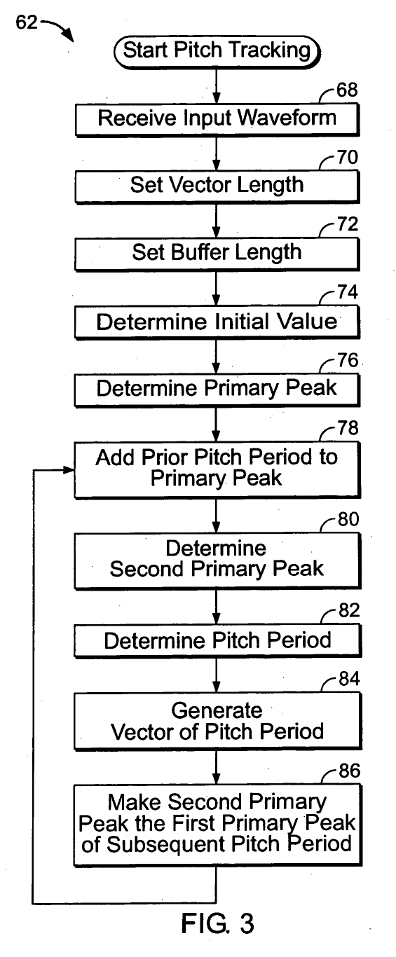

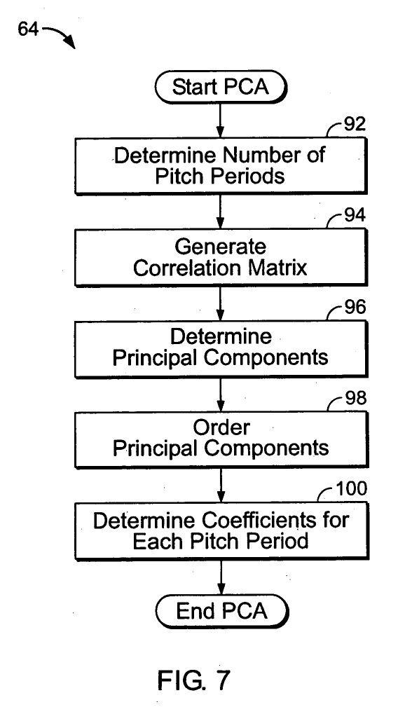

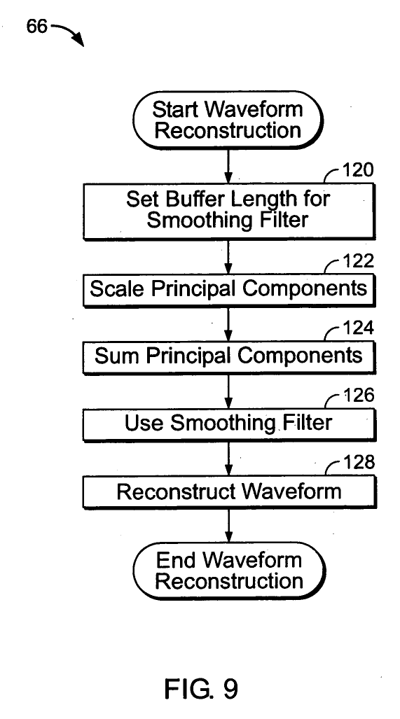

Referring to FIG. 2, as will be described below, telecommunications system 5 uses a process 60 to implement speech compression. Process 60 determines (62) the pitch period of the input waveform using a pitch tracking process 62 (FIG. 3). Process 60 generates (64) PCA components and PCA coefficients using a principal components process 64 (FIG. 7). Process 60 reconstructs (66) the input waveform received from the PCA components and coefficients. Details of a waveform reconstruction process 66 will be described in FIG. 9.

A. Pitch Tracking

Process 60 is one example of an implementation to use principal component analysis (PCA) to determine trends in the slight changes that modify a waveform across its pitch periods including quasi-periodic waveforms like speech signals. In order to analyze the changes that occur from one pitch period to the next, a waveform is divided into its pitch periods using pitch tracking process 62.

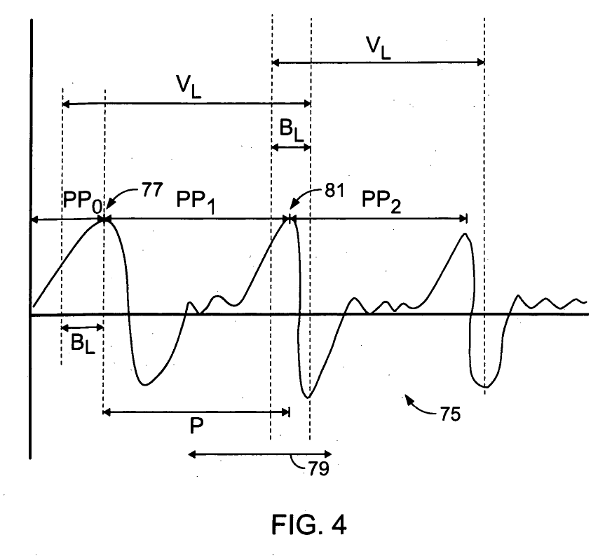

Referring to FIGS. 3 and 4, pitch tracking process 62 receives (68) an input waveform 75 to determine the pitch periods. Even though the waveforms of human speech are quasi-periodic, human speech still has a pattern that repeats for the duration of the input waveform 75. However, each iteration of the pattern, or “pitch period” (e.g., PP₁) varies slightly from its adjacent pitch periods, e.g., PP₀ and PP₂. Thus, the waveforms of the pitch periods are similar, but not identical, thus making the time duration for each pitch period unique.

Since the pitch periods in a waveform vary in time duration, the number of sampling points in each pitch period generally differs and thus the number of dimensions required for each vectorized pitch period also differs. To adjust for this inconsistency, pitch tracking process 62 designates (70) a standard vector (time) length, V_{L}. After pitch tracking process 62 is executing, the pitch tracking process chooses the vector length to be the average pitch period length plus a constant, for example, 40 sampling points. This allows for an average buffer of 20 sampling points on either side of a vector. The result is all vectors are a uniform length and can be considered members of the same vector space. Thus, vectors are returned where each vector has the same length and each vector includes a pitch period.

Pitch tracking process 62 also designates (72) a buffer (time) length, B_{L}, which serves as an offset and allows the vectors of those pitch periods that are shorter than the vector length to run over and include sampling points from the next pitch period. As a result, each vector returned has a buffer region of extra information at the end. This larger sample window allows for more accurate principal component calculations, but also requires a greater bandwidth for transmission. In the interest of maximum bandwidth reduction, the buffer length may be kept to between 10 and 20 sampling points (vector elements) beyond the length of the longest pitch period in the waveform.

At 8 kHz, a vector length that includes 120 sample points and an offset that includes 20 sampling units can provide optimum results.

Pitch tracking process 62 relies on the knowledge of the prior period duration, and does not determine the duration of the first period in a sample directly. Therefore, pitch tracking process 62 determines (74) an initial period length value by finding a real cepstrum of the first few pitch periods of the speech signal to determine the frequency of the signal. A cepstrum is an anagram of the word “spectrum” and is a mathematical function that is the inverse Fourier transform of the logarithm of the power spectrum of a signal. The cepstrum method is a standard method for estimating the fundamental frequency (and therefore period length) of a signal with fluctuating pitch.

A pitch period can begin at any point along a waveform, provided it ends at a corresponding point. Pitch tracking process 62 considers the starting point of each pitch period to be the primary peak or highest peak of the pitch period.

Pitch tracking process 62 determines (76) the first primary peak 77. Pitch tracking process 62 determines a single peak by taking the input waveform, sampling the input waveform, taking the slope between each sample point and taking the point sampling point closest to zero. Pitch tracking process 62 searches several peaks and takes the peak with the largest magnitude as the primary peak 77. Pitch tracking process 62 adds (78) the prior pitch period to the primary peak. Pitch tracking process 62 determines (80) a second primary peak 81 locating a maximum peak from a series of peaks 79 centered a time period, P, (equal to the prior pitch period, PP₀) from the first primary peak 77. The peak whose time duration from the primary peak 77 is closest to the time duration of the prior pitch period PP₀ is determined to be the ending point of that period (PP₁) and the starting point of the next (PP₁). The second primary peak is determined by analyzing three peaks before or three peaks after the prior pitch period from the primary peak and designating the largest peak of those peaks as the second peak.

Process 60 vectorizes (84) the pitch period. Performing pitch tracking process 62 recursively, pitch tracking process 62 returns a set of vectors; each set corresponding to a vectorized pitch period of the waveform. A pitch period is vectorized by sampling the waveform over that period, and assigning the ith sample value to the ith coordinate of a vector in Euclidean n-dimensional space, denoted by [symbol] ⁿ, where the index i runs from 1 to n, the number of samples per period. Each of these vectors is considered a point in the space [symbol] ⁿ.

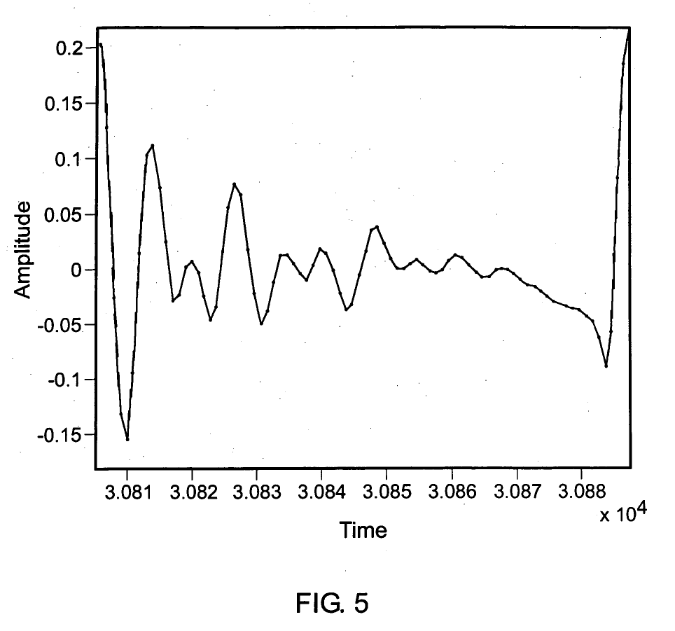

FIG. 5 shows an illustrative sampled waveform of a pitch period. The pitch period includes 82 sampling points (denoted by the dots lying on the waveform) and thus when the pitch period is vectorized, the pitch period can be represented as a single point in an 82-dimensional space.

Pitch tracking process 62 designates (86) the second primary peak as the first primary peak of the subsequent pitch period and reiterates (78)-(86).

Thus, pitch tracking process 62 identifies the beginning point and ending point of each pitch period. Pitch tracking process 62 also accounts for the variation of time between pitch periods. This temporal variance occurs over relatively long periods of time and thus there are no radical changes in pitch period length from one pitch period to the next. This allows pitch tracking process 62 to operate recursively, using the length of the prior period as an input to determine the duration of the next.

Pitch tracking process 62 can be stated as the following recursive function:

$$f ( {p}_{prev} , {p}_{new} ) = \{ \begin{matrix}f ( {p}_{new} , {p}_{next} ) : \vert s - d ( {p}_{new} , {p}_{0} ) \vert \leq \vert s - d ( {p}_{prev} , {p}_{0} ) \vert \\ d ( {p}_{prev} , {p}_{0} ) : \vert s - d ( {p}_{new} , {p}_{0} ) \vert > \vert s - d ( {p}_{prev} , {p}_{0} ) \vert\end{matrix}$$

The function f(p,p′) operates on pairs of consecutive peaks p and p′ in a waveform, recurring to its previous value (the duration of the previous pitch period) until it finds the peak whose location in the waveform corresponds best to that of the first peak in the waveform. This peak becomes the first peak in the next pitch period. In the notation used here, the letter p subscripted, respectively, by “prev,” “new,” “next” and “0,” denote the previous, the current peak being examined, the next peak being examined, and the first peak in the pitch period respectively. s denotes the time duration of the prior pitch period, and d(p,p′) denotes the duration between the peaks p and p′.

A representative example of program code (i.e., machine-executable instructions) to implement process 62 is the following code using MATHLAB:

function [a, t] = pitch(infile, peakarray)
% PITCH2 separate pitch-periods.
% PITCH2(infile, peakarray) infile is an array of a .wav
% file generally read using the wavread( ) function.
% peakarray is an array of the vectorized pitch periods of
% infile.
wave = wavread(infile);
siz = size(wave);
n = 0;
t = [0 0];
a = [];
w = 1;
count = size(peakarray);

| | |
|---|---|
| length = 120; | % set vector |
| offset = 20; | % length |
| while wave(peakarray(w)) > wave(peakarray(w+1)) | % find primary |
| w = w+1; | % peak |

end

| | |
|---|---|
| left = peakarray(w+1); | % take real |
| y = rceps(wave); | % cepstrum of |
| x = 50; | % waveform |

while y(x) ˜= max(y(50:125))
x = x+1;
end

| prior = x; | | % find pitch period length |
|---|---|---|
| period = zeros(1, length); | | % estimate |
| for x = (w+1):count(1,2)−1 | | % pitch tracking |
| | right = peakarray(x+1); | % method |

trail = peakarray(x);
if (abs(prior−(right−left))>abs(prior−(trail−left)))
n = n + 1;
d = left−offset;
if (d+length) < siz(1)

t(n,:) = [offset, (offset+(trail−left))];
for y = 1:length
if (y+d−1) > 0
period(y) = wave(y+d−1);

end

end

| | |
|---|---|
| a(n, :) = period; | % generate vector |
| prior = trail−left; | % of pitch period |

left = trail;
end

Of course, other code (or even hardware) may be used to implement pitch tracking process 62.

B. Principal Component Analysis

Principal component analysis is a method of calculating an orthogonal basis for a given set of data points that defines a space in which any variations in the data are completely uncorrelated. The symbol, “ [symbol] ⁿ” is defined by a set of n coordinate axes, each describing a dimension or a potential for variation in the data. Thus, n coordinates are required to describe the position of any point. Each coordinate is a scaling coefficient along the corresponding axis, indicating the amount of variation along that axis that the point possesses. An advantage of PCA is that a trend appearing to span multiple dimensions in [symbol] ⁿ can be decomposed into its “principal components,” i.e., the set of eigen-axes that most naturally describe the underlying data. By implementing PCA, it is possible to effectively reduce the number of dimensions. Thus, the total amount of information required to describe a data set is reduced by using a single axis to express several correlated variations.

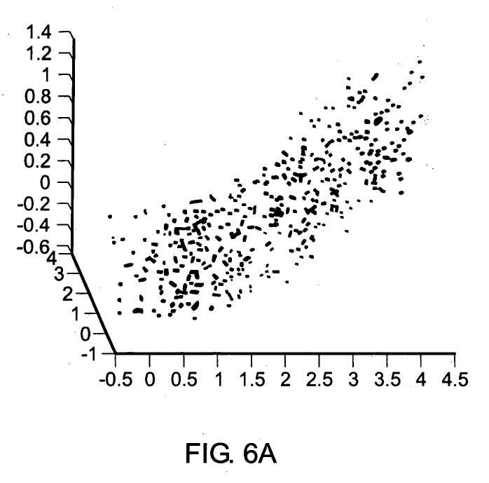

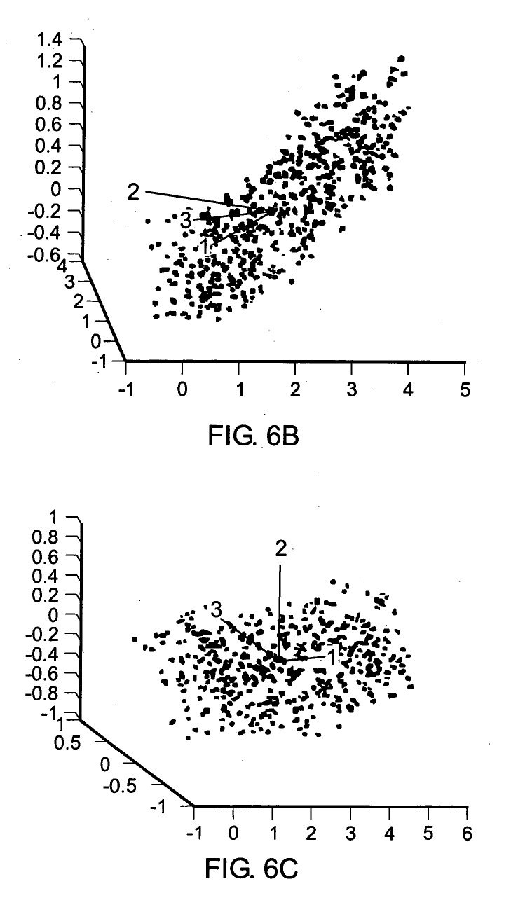

For example, FIG. 6A shows a graph of data points in 3-dimensions. The data in FIG. 6B are grouped together forming trends. FIG. 6B shows the principal components of the data in FIG. 6A. FIG. 6C shows the data redrawn in the space determined by the orthogonal principal components. There is no visible trend in the data in FIG. 6C as opposed to FIGS. 6A and 6B. In this example, the dimensionality of the data was not reduced because of the low-dimensionality of the original data. For data in higher dimensions, removing the trends in the data reduces the data's dimensionality by a factor of between 20 and 30 in routine speech applications. Thus, the purpose of using PCA in this method of compressing speech is to describe the trends in the pitch-periods and to reduce the amount of data required to describe speech waveforms.

Referring to FIG. 7, principal components process 64 determines (92) the number of pitch periods generated from pitch tracking process 62. Principal components process 64 generates (94) a correlation matrix.

The actual computation of the principal components of a waveform is a well-defined mathematical operation, and can be understood as follows. Given two vectors x and y, xy^{T} is the square matrix obtained by multiplying x by the transpose of y. Each entry [xy^{T}]_{i,j} is the product of the coordinates xᵢ and yⱼ. Similarly, if X and Y are matrices whose rows are the vectors Xᵢ and yⱼ, respectively, the square matrix XY^{T} is a sum of matrices of the form [xy^{T}]_{i,j}:

$${XY}^{T} = {\sum }_{i , j}^{} {x}_{i} {y}_{j}^{T} .$$

XY^{T} can therefore be interpreted as an array of correlation values between the entries in the sets of vectors arranged in X and Y. So when X=Y, XX^{T} is an “autocorrelation matrix,” in which each entry [XX^{T}]_{i,j} gives the average correlation (a measure of similarity) between the vectors xᵢ and xⱼ. The eigenvectors of this matrix therefore define a set of axes in [symbol] ⁿ corresponding to the correlations between the vectors in X. The eigen-basis is the most natural basis in which to represent the data, because its orthogonality implies that coordinates along different axes are uncorrelated, and therefore represent variation of different characteristics in the underlying data.

Principal components process 64 determines (96) the principal components from the eigenvalue associated with each eigenvector. Each eigenvalue measures the relative importance of the different characteristics in the underlying data. Process 64 sorts (98) the eigenvectors in order of decreasing eigenvalue, in order to select the several most important eigen-axes or “principal components” of the data.

Principal components process 64 determines (100) the coefficients for each pitch period. The coordinates of each pitch period in the new space are defined by the principal components. These coordinates correspond to a projection of each pitch period onto the principal components. Intuitively, any pitch period can be described by scaling each principal component axis by the corresponding coefficient for the given pitch period, followed by performing a summation of these scaled vectors. Mathematically, the projections of each vectorized pitch period onto the principal components are obtained by vector inner products:

$${x}^{′} = {\sum }_{i = 1}^{n} ( {e}_{i} \cdot x ) {e}_{i} .$$

In this notation, the vectors x and x′ denote a vectorized pitch period in its initial and PCA representations, respectively. The vectors eᵢ are the ith principal components, and the inner product eᵢ·x is the scaling factor associated with the ith principal component.

Therefore, if any pitch period can be described simply by the scaling and summing the principal components of the given set of pitch periods, then the principal components and the coordinates of each period in the new space are all that is needed to reconstruct any pitch period and thus the principal components and coefficients are the compressed form of the original speech signal. In order to reconstruct any pitch period of n sampling points, n principal components are necessary.

In the present case, the principal components are the eigenvectors of the matrix SS^{T}, where the ith row of the matrix S is the vectorized ith pitch period in a waveform. Usually the first 5 percent of the principal components can be used to reconstruct the data and provide greater than 97 percent accuracy. This is a general property of quasi-periodic data. Thus, the present method can be used to find patterns that underlie quasi-periodic data, while providing a concise technique to represent such data. By using a single principal component to express correlated variations in the data, the dimensionality of the pitch periods is greatly reduced. Because of the patterns that underlie the quasi-periodicity, the number of orthogonal vectors required to closely approximate any waveform is much smaller than is apparently necessary to record the waveform verbatim.

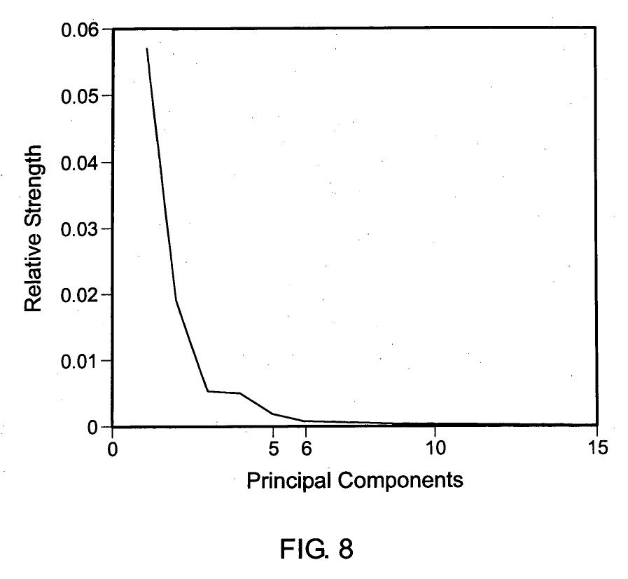

FIG. 8 shows an eigenspectrum for the principal components of the ‘aw’ phoneme. The eigenspectrum displays the relative importance of each principal component in the ‘aw’ phoneme. Here only the first 15 principal components are displayed. The steep falloff occurs far to the left on the horizontal axis. This indicates the importance of later principal components is minimal. Thus, using between 5 and 10 principal components would allow reconstruction of more than 95% of the original input signal. The optimum tradeoff between accuracy and number of bits transmitted typically requires six principal components. Thus, the eigenspectrum is a useful tool in determining how many principal components are required for the compression of a given phoneme (speech sound).

A representative example of program code (i.e., machine-executable instructions) to implement principal components process 64 is the following code using MATHLAB:

function [v,c] = pca(periodarray, Nvect)
% PCA principal component analysis
% pca(periodarray) performs principal component analysis on an
% array where each row is an observation (pitch-period) and
% each column a variable.

| | |
|---|---|
| n = size(periodarray); | % find # of pitch periods |

n = n(1);
l = size(periodarray(1,:));
v = zeros(Nvect, l(2));
c = zeros(Nvect, n);

| | |
|---|---|
| e = cov(periodarray); | % generate correlation matrix |
| [vects, d] = eig(e); | % compute principal components |

vals = diag(d);

| | |
|---|---|
| for x = 1:Nvect | % order principal components |

y = 1;
while vals(y) ˜= max(vals);

y = y + 1;

| end | |
|---|---|
| vals(y) = −1; | |
| v(x,:) = vects(:,y)'; | % compute coefficients for |
| for z = 1:n | % each period |

c(x,z) = dot(v(x,:), periodarray(z,:));

end

end

Of course, other code (or even hardware) may be used to implement principal components process 64. After using pitch tracking process 62 and principal components process 64, the input waveform is considered to be a compressed waveform where the principal components and their coefficients are the compressed waveform.

C. Waveform Reconstruction

Waveform reconstruction process 66 synthesizes the waveform by sequentially reconstructing each pitch period by scaling the principal components by their coefficients for a given period and summing the scaled components. As each pitch period is reconstructed, the pitch period is concatenated to the prior pitch period to reconstruct the waveform. To decrease the bit rate necessary for this compression technique, only a small number of principal components are used to compress the signal. As a result the reconstructed waveforms are slightly different from the originals, and so a smoothing filter can be used in the concatenation process to smooth over small inconsistencies. A trapezoidal smoothing filter known as an alpha-blending filter can be used.

The principal components of a set of pitch periods are, in essence, vectors in the same dimensional space as the vectorized pitch periods. Thus, since each of the points in space representing a pitch period has the same number of coordinates as one of the axes that defines that space (the principal components), each principal component itself is a waveform of a length of each of the pitch-period-length vectors.

Waveform reconstruction process 66 sets (120) the buffer length for the smoothing filter. Waveform reconstruction process 66 scales (122) the principal components and sums (124) the principal components and uses (126) the smoothing filter to reconstruct (128) the input waveform.

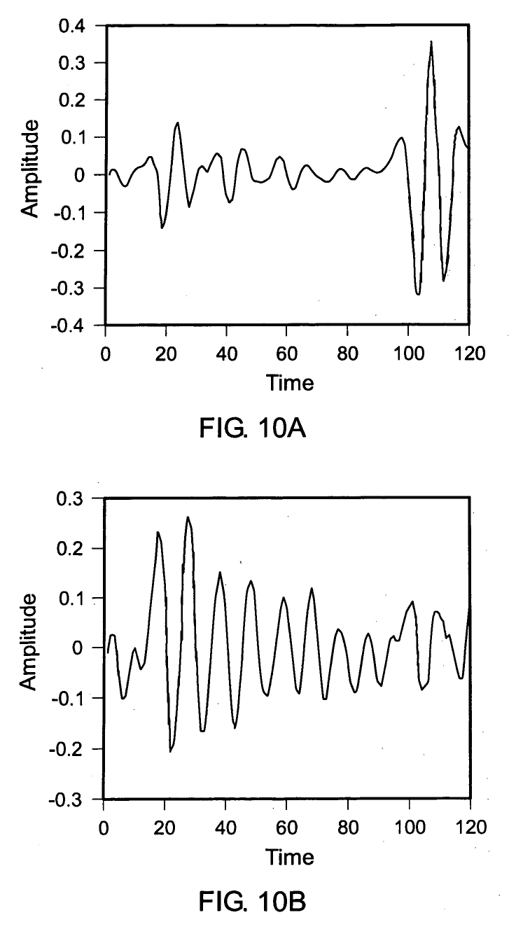

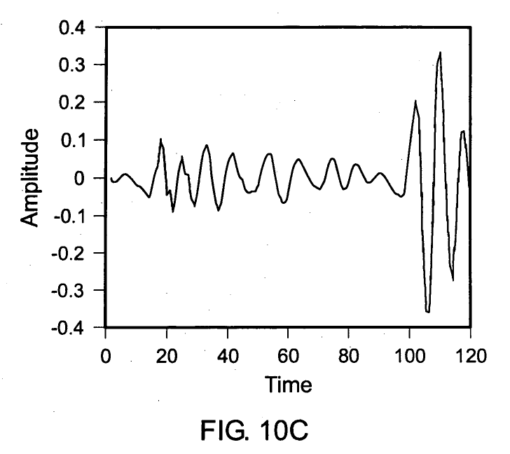

FIGS. 10A-10C show the waveform representations of the first three principal components generated from a set of pitch periods. These vectors need only be scaled by the proper coefficients and summed together to reconstruct any pitch period in the waveform.

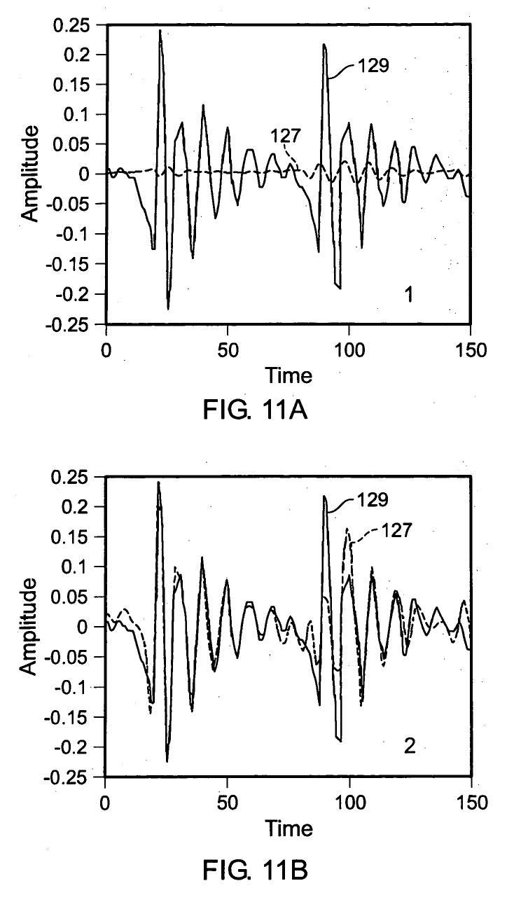

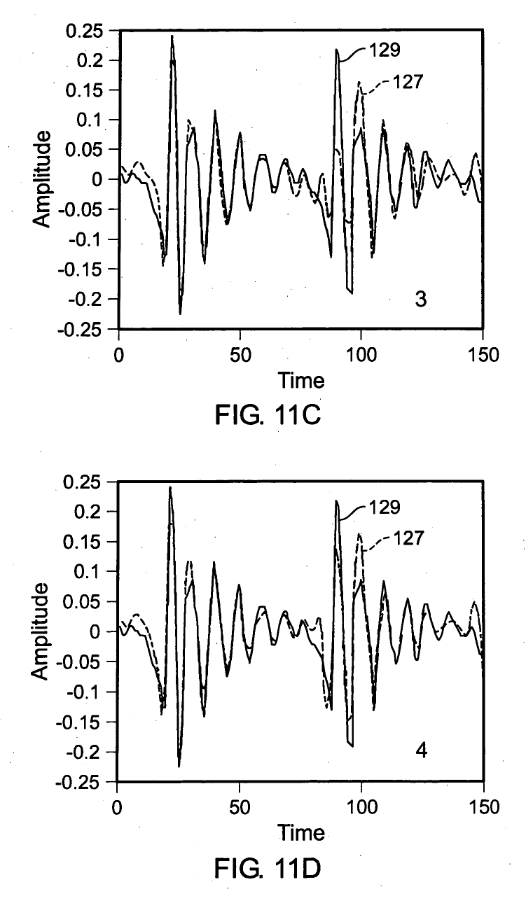

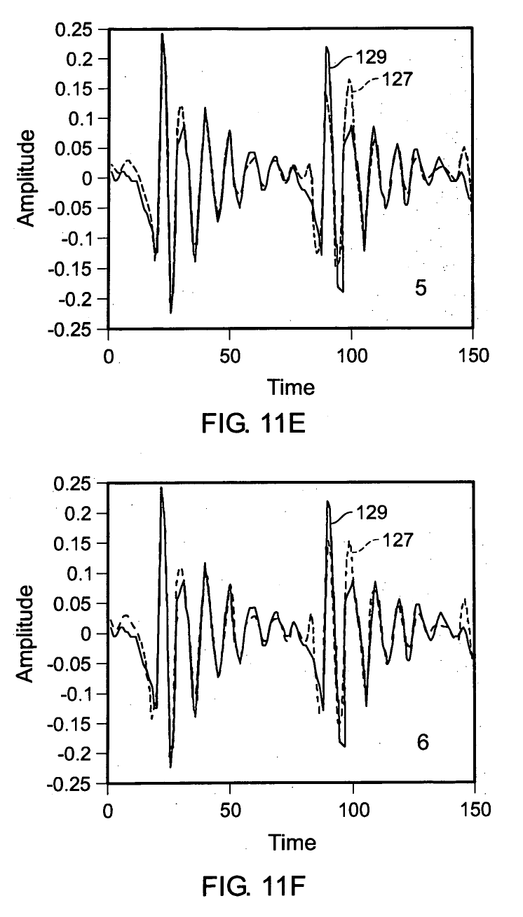

Referring to FIGS. 11A-11F, in each of these figures, an additional principal component has been scaled and added to the prior figure to construct a closer approximation 127 to the actual waveform 129 so that FIG. 11A includes only one principal component, whereas FIG. 11F includes six principal components. Therefore, it is possible to reconstruct any pitch period with relatively high accuracy with a small number of principal components and their corresponding coefficients for each pitch period. The reconstructed pitch periods may differ slightly from the periods that generated them because not all of the principal components were used, and thus, when the pitch periods are concatenated, a slight discontinuity may occur at the point where one pitch period ends and the next begins. This discontinuity is eliminated using alpha-blending filter.

A representative example of program code (i.e., machine-executable instructions) to implement waveform reconstruction process 66 is the following code using MATHLAB:

function w = pcs(pcmtx, coeffmtx, times)
% PCS principal component synthesis
% pcs(pcmtx, coeffmtx, times) returns a synthesized wave (w))
d = size(times);
s = size(pcmtx);
Nvect = s(1);
n = d(1);
v = 0;

| | |
|---|---|
| buffer = times(1,1); | % set buffer length for |
| c = buffer+1; | % smoothing filter (alpha |

| | | % blend) |
|---|---|---|
| for x = 1:n | | % determine length of |
| | v = v+(times(x,2)−times(x,1)); | % reconstructed wave |

end
w = zeros(1,v+c);

| | |
|---|---|
| for x = 1:n | % scale and sum principal |

| | |
|---|---|
| t = 0; | % components for a single |
| for y = 1:Nvect | % pitch period |

t = t + pcmtx(y,:)*coeffmtx(y,x);

end
bcount = buffer;
for z = 1:(times(x,2))

| | |
|---|---|
| w(c−buffer*x) = ((w(c− | % alpha blend and build wave |

buffer*x))*(bcount/buffer))
+((t(z))*((buffer−bcount)/buffer));

c = c+1;
if bcount>0

bcount = bcount −1;

end

end

end

Of course, other code (or even hardware) may be used to implement waveform reconstruction process 66.

The speech coding standards in digital cellular applications (the most bandwidth restrictive voice transmission protocols) range from 13 kb/s to 3.45 kb/s. That is, a speech waveform transmitted raw at 64 kb/s (8-bit samples at 8 kHz) can be compressed to a 3.45 kb/s signal. The method for compressing speech discussed here if applied to individual voice vowel phonemes can achieved compression to rates of 3.2 kb/s with highly accurate reconstruction.

This speech compression technique is useful for real-time speech coding applications. In any real-time application, this technique is paired with a technique of determining phoneme (speech sound) changes because maximum compression is achieved when a set of principal components is calculated for a single phoneme.

Any real-time speech-coding technique involves delay. The algorithmic delay of this technique of speech coding depends on the number of pitch periods used to calculate the principal components that will be used to code for the entire phoneme. If the principal components were calculated from all of the pitch periods in a speech sample, the algorithmic delay could be too long to accommodate real-time communication. Thus the principal components for a phoneme are calculated only from the first few pitch periods of the sample. The pitch periods for a given phoneme are similar, so the principal components calculated from the first pitch periods will suffice to code for the next pitch periods for a short period time. However, if the pitch periods change, or if the phoneme being spoken changes, the principal components are recalculated to represent that phoneme effectively.

One effective way of determining how well a set of principal components can describe a given pitch period is to calculate the distance of that pitch period from the centroid of the data that generated the pitch periods. The farther from the centroid a given pitch period is, the lesser the ability of a small number of principal components to reconstruct that pitch period accurately.

Mathematically, the centroid of a set of vectors in [symbol] ⁿ as an unweighted average position is defined as:

$${r}_{c} = \frac{1}{k} {\sum }_{i = 1}^{k} {r}_{i} .$$

That is, where rᵢ are the k given position vectors of the data, and r_{c} is the position vector of the centroid. The n-dimensional distance of a point x from the centroid is therefore given by

$$d ( {r}_{c} , x ) = \sqrt{{\sum }_{i = 1}^{n} {( {r}_{ci} - {x}_{i} )}^{2}} .$$

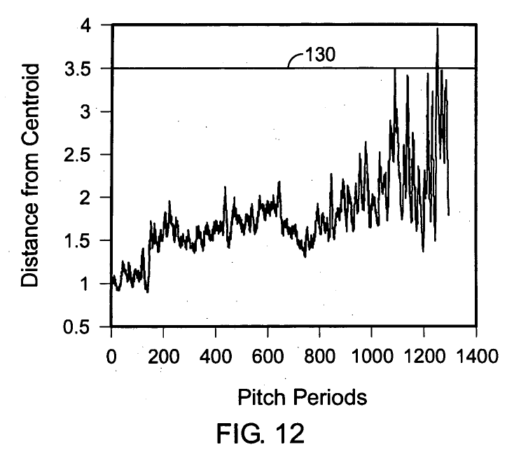

For example, FIG. 12 shows the distance of a set of pitch periods from their centroid. As time progresses, the ability of the principal components to effectively code for the pitch periods decreases. Thus, at a certain threshold 130, the principal components are recalculated.

The point at which the principal components should be recalculated is a tolerance issue. The more often the principal components are recalculated, the better the quality of the reproduced speech. However, frequent recalculation of the principal components causes a higher bit rate for transmission of the coded speech. Thus, the tolerance for noise must be balanced with the bit rate constraints placed on the coding method by the channel across which the transmission is to take place.

When implemented in real-time, this coding technique will not produce a constant stream of data. A surge of data will be initially transmitted. This surge is comprised of the principal components of the upcoming phoneme. The principal components will be followed by a low bit rate stream of the coefficients for each pitch period in real-time as it is spoken. At the point where the principal components no longer suffice, a new set of principal components are calculated and transmitted, causing another surge in the bit rate of the transmission to be followed by a long stream of coefficients, and so on. The coefficients require much less bandwidth for transmission, and thus the data stream will be a series of short bit rate surges followed by long, low-bit rate data streams.

Reducing the Bit Rate

Techniques can be used to reduce the bit rate required for speech transmission even further with the above approach to speech compression. One technique would use a linear predictive-type method of reducing the bit rate required by the principal component coefficients. Since the coefficients for given principal components follow trends over time, it may be possible for the receiving end of the transmission to predict the next values of the coefficients of the principal components and thus guess the shape of the next pitch period. This prediction would reduce the amount of data needed for transmission by requiring only an occasional corrective value to be transmitted if the predicted value is inaccurate, as opposed to transmitting every coefficient. Another technique can be used to eliminate artifacts remaining in the waveforms after compression. The artifact arises because the waveform of each pitch period contains a great deal of information about the acoustic settings in which the sound was spoken. If this information can be removed prior to coding, it will greatly reduce the bit rate of transmission.

A. Coefficient Prediction

Audible changes in a waveform across pitch periods occur slowly, over relatively long periods of time. The coefficients of the principal components for each pitch period describe the constantly occurring variations and indicate how much of each variation their respective pitch period contains. Thus, the coefficients for a given principal component over a series of pitch periods generally show very slow, definite trends.

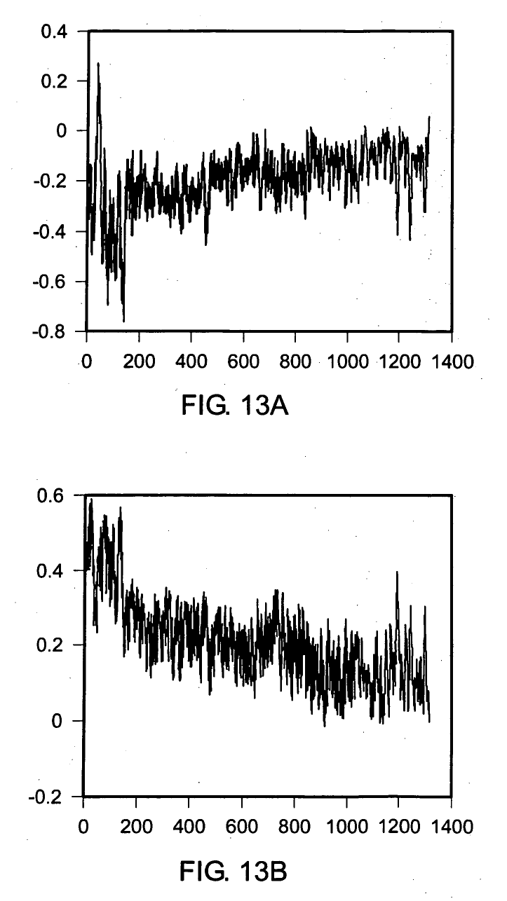

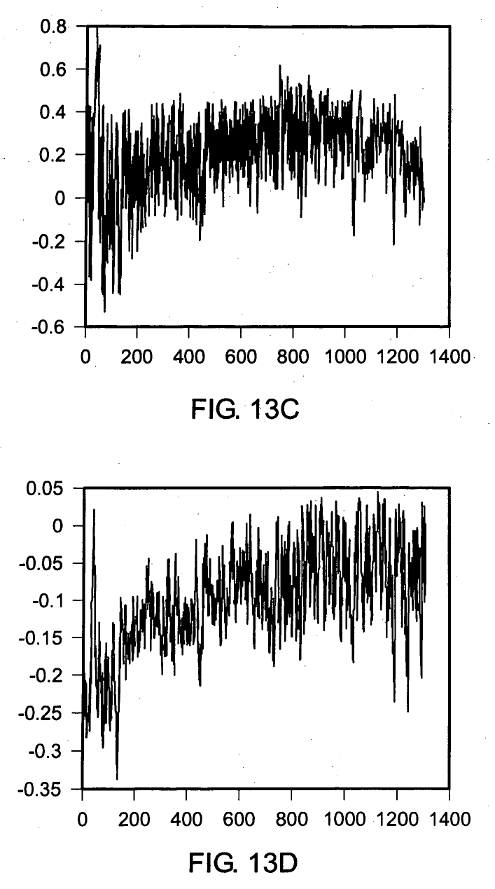

FIGS. 13A-13D show the values of the coefficients for the first four principal components in a set over time. The definite trends depicted in these four principal components would make prediction of the coefficient values possible.

Being able to predict the coefficient values would greatly increase the compression ratio and could reduce the bit rate necessary for transmission by a factor of 101 or even as high as 102 for signals with particularly predictable trends. This notion of a meta-trend, as distinct from the individual correlations that make PCA possible, is a general property of quasi-periodic waveforms, and is not particular to human speech.

B. Eliminating Artifacts

The primary purpose of speech compression is to convey the message contained in the speech signal while using the least amount of bandwidth. Thus, the accuracy of the phonemes is of greatest importance. The acoustic surroundings of the speaker (echo and background noise, for instance) are of much less importance and can even prove annoying in extreme cases.

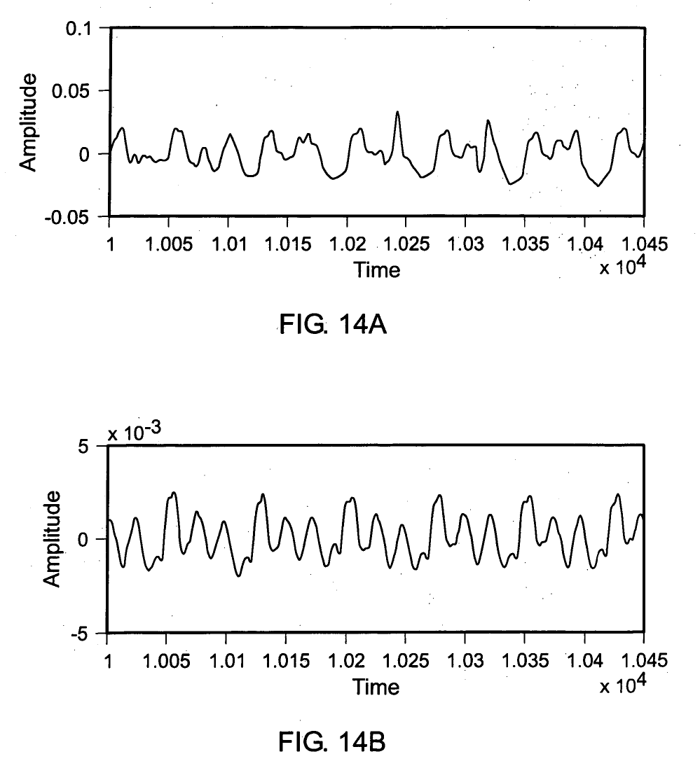

Referring to FIG. 14, two waveforms of the same phoneme spoken in different acoustic settings may contain different shapes and attributes. The different shapes of the waveforms indicate that the waveforms contain information describing the acoustic setting. A microphone in constant motion thus may register very different signals over time as a result of the constantly changing background despite the fact that the phoneme being spoken may not have changed. Thus process 60 may be modified to recalculate principal components to adjust for changing acoustics. This recalculation increases the bit rate required for transmission. If these artifacts can be removed prior to coding, the bit rate of transmission can be further reduced.

Speech Recognition

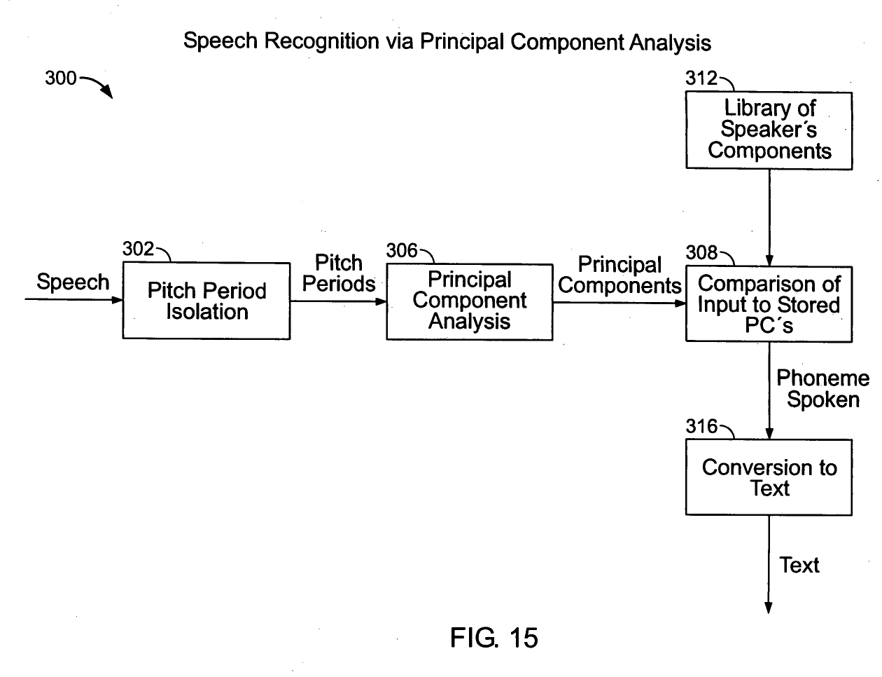

Referring to FIG. 15, in some embodiments, PCA can be implemented in speech recognition applications such as using a process 300, for example. After receiving a speech waveform spoken from a speaker, process 300 isolates (302) the pitch periods using process 62, for example. Process 300 performs (306) a principal component analysis from the pitch periods to generate the principal components by using process 64, for example. Process 300 compares (308) the principal components from a library of the speaker's principal components 312, previously stored, with the principal components derived from the speech waveform. If the principal components are identical with a tolerance, process 300 generates phonemes. Process 300 converts (316) the phonemes spoken to text.

Speech Synthesis

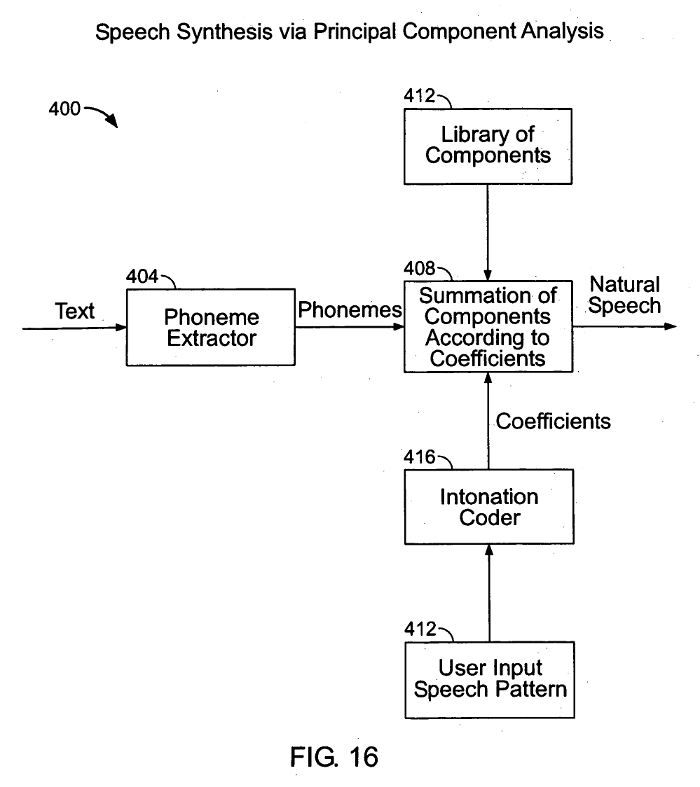

Referring to FIG. 16, in other embodiments, PCA can be implemented in speech synthesis applications such as using a process 400, for example. Process 400 generates (404), based on a text input, phonemes. Process 400 sums (408) principal components from a library of principal components for a speaker and a set of coefficients from a user's speech pattern and combines them to form natural speech. In some embodiments, prior to combining the coefficients, process 400 codes (416) the intonations of the speaker's speech pattern. For example, intonations such as a deep voice or a soft pitch can be reflected in the coefficients. These intonations can be selected by the user.

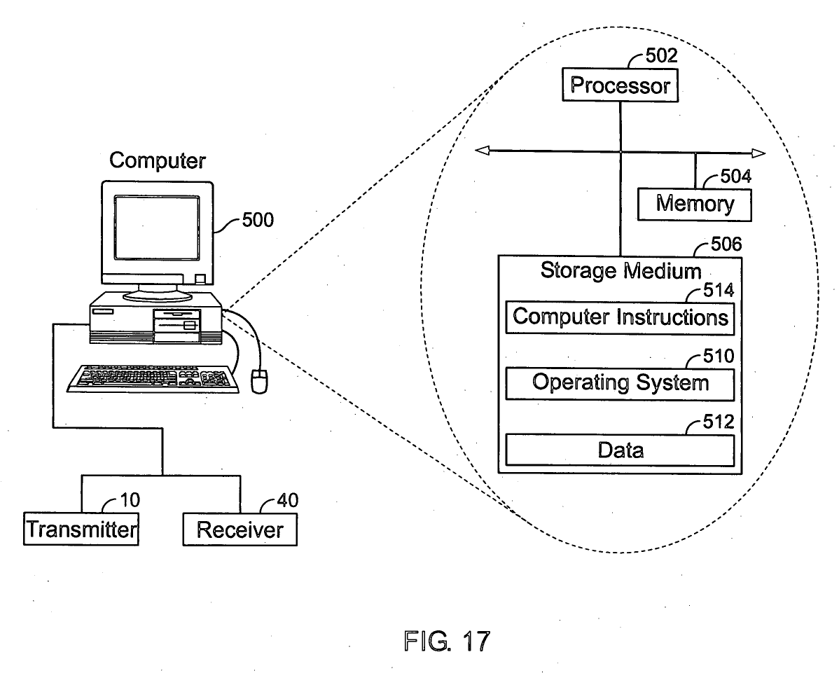

FIG. 17 shows a computer 500 for speech compression using process 60. Computer 500 includes a processor 502, a memory 504, a storage medium 506 (e.g., read only memory, flash memory, disk etc.), transmitter 10 for sending signal to a second computer (not shown) and receiver 40 to decompress a signal received from the second computer. In one implementation the computer is part of a cell phone. The computer can be a general purpose or special purpose computer, e.g., controller, digital signal processor, etc. Storage medium 506 stores operating system 510, data 512 for speech compression, and computer instructions 514 which are executed by processor 502 out of memory 504 to perform process 60.

Process 60 is not limited to use with the hardware and software of FIG. 17; it may find applicability in any computing or processing environment and with any type of machine that is capable of running a computer program. Process 60 may be implemented in hardware, software, or a combination of the two. For example, process 60 may be implemented in a circuit that includes one or a combination of a processor, a memory, programmable logic and logic gates. Process 60 may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform process 60 and to generate output information.

Each such program may be implemented in a high level procedural or object-oriented programming language to communicate with a computer system. However, the programs can be implemented in assembly or machine language. The language may be a compiled or an interpreted language. Each computer program may be stored on a storage medium or device (e.g., CD-ROM, hard disk, or magnetic diskette) that is readable by a general or special purpose programmable computer for configuring and operating the computer when the storage medium or device is read by the computer to perform process 60. Process 60 may also be implemented as a machine-readable storage medium, configured with a computer program, where upon execution, instructions in the computer program cause the computer to operate in accordance with process 60.

The processes are not limited to the specific embodiments described herein. For example, the processes are not limited to the specific processing order of FIGS. 2, 3, 7, 9, 15 and 16. Rather, the blocks of FIGS. 2, 3, 7, 9, 15 and 16 may be re-ordered, as necessary, to achieve the results set forth above.

Other embodiments not described herein are also within the scope of the following claims.

What is claimed is:

1. A method of determining a pitch period, comprising:
determining a first primary peak of an input signal; and
determining a second primary peak of the input signal by locating a maximum peak from a series of peaks centered a period of time, equal to a prior pitch period, from the first primary peak.

2. The method of claim 1 wherein the input signal is a quasi-periodic waveform.

3. The method of claim 2 wherein the quasi-periodic signal is a speech waveform.

4. The method of claim 1 wherein the series of peaks comprises six peaks.

5. The method of claim 1, further comprising:
setting a buffer length.

6. The method of claim 5, further comprising:
setting a vector length.

7. The method of claim 5 wherein the buffer length comprises 20 sample points at 8 kHz in a speech signal.

8. The method of claim 6 wherein the vector length comprises 120 sample points at 8 kHz in a speech signal.

9. The method of claim 1, further comprising:
designating the second primary peak as a first primary peak of a second pitch period subsequent to the pitch period.

10. The method of claim 1 wherein the prior pitch period length is determined from taking a cepstrum of waveforms prior to the pitch period.

11. The method of claim 1, further comprising:
generating a vector of each pitch period.

12. An article comprising a machine-readable medium that stores executable instructions for determining a pitch period, the instructions causing a machine to:
determine a first primary peak of an input signal; and
determine a second primary peak of the input signal by locating a maximum peak from a series of peaks centered a period of time, equal to a prior pitch period, after the first primary peak.

13. The article of claim 12 wherein the input signal is a quasi-periodic waveform.

14. The article of claim 13 wherein the quasi-periodic signal is a speech waveform.

15. The article of claim 12 wherein the series of peaks comprises six peaks.

16. The article of claim 12, further comprising instructions causing the machine to:
set a buffer length.

17. The article of claim 16, further comprising instructions causing the machine to:
set a vector length.

18. The article of claim 16 wherein the buffer length comprises 20 sample points at 8 kHz in a speech signal.

19. The article of claim 17 wherein the vector length comprises 120 sample points at 8 kHz in a speech signal.

20. The article of claim 12, further comprising instructions causing the machine to:
designate the second primary peak as a first primary peak of a second pitch period subsequent to the pitch period.

21. The article of claim 17 wherein the prior pitch period is determined from taking a cepstrum of waveforms prior to the pitch period.

22. The article of claim 12, further comprising instructions causing the machine to:
generate a vector of each pitch period.

23. An apparatus comprising:
a memory that stores executable instructions for determining a pitch period; and
a processor that executes the instructions to:
determine a first primary peak of an input signal; and
determine a second primary peak of the input signal by locating a maximum peak from a series of peaks centered a period of time, equal to a prior pitch period, after the first primary peak.

24. The apparatus of claim 23 wherein the input signal is a quasi-periodic waveform.

25. The apparatus of claim 24 wherein the quasi-periodic signal is a speech waveform.

26. The apparatus of claim 23 wherein the series of peaks comprises six peaks.

27. The apparatus of claim 23 wherein the processor executes the instructions to:
set a buffer length.

28. The apparatus of claim 27 wherein the processor executes the instructions to:
set a vector length.

29. The apparatus of claim 27 wherein the buffer length comprises 20 sample points at 8 kHz in a speech signal.

30. The apparatus of claim 28 wherein the vector length comprises 120 sample points at 8 kHz in a speech signal.

31. The apparatus of claim 23 wherein the processor executes the instructions to:
designate the second primary peak as a first primary peak of a second pitch period subsequent to the pitch period.

32. The apparatus of claim 28 wherein the prior pitch period is determined from taking a cepstrum of waveforms prior to the pitch period.

33. The apparatus of claim 23 wherein the processor executes the instructions to:
generate a vector of each pitch period.
